(19) United States
(12) Patent Application Publication
(10) Pub. No.: US 2018/0082119 A1
(43) Pub. Date: Mar. 22, 2018

(54) SYSTEM AND METHOD FOR REMOTELY ASSISTED USER-ORIENTATION

(71) Applicant: PROJECT RAY LTD., Yokneam (IL)

(72) Inventors: BOAZ ZILBERMAN, RAMAT HASHARON (IL); MICHAEL VAKULENKO, ZICHRON YAAKOV (IL); NIMROD SANDLERMAN, RAMAT GAN (IL)

(21) Appl. No.: 15/708,147

(22) Filed: Sep. 19, 2017

Related U.S. Application Data
(60) Provisional application No. 62/396,239, filed on Sep. 19, 2016.

(51) Int. Cl. G06K 9/00; G06T 7/246; G08B 7/06

(52) U.S. Cl. CPC G06K 9/00671; G08B 7/066; G06T 7/246

(57) ABSTRACT

A system for remotely navigating a local-user manually operating a mobile device associated with an imaging device such as a camera, the system performing: communicating in real-time, from an imaging device associated with the first user, to a remote station, imaging data acquired by the imaging device, analyzing the imaging data, in the remote station, to provide actual direction of motion of the first user, acquiring, by the remote station, an indication of a required direction of motion of the first user, communicating the indication of a required direction of motion to a mobile device associated with the first user, and providing, by the mobile device to the first user, at least one humanly sensible cue, where the cue indicates a difference between the actual direction of motion of the first user and the indication of a required direction of motion.

### FIELD

The method and apparatus disclosed herein are related to the field of personal navigation, and, more particularly, but not exclusively to systems and methods enabling a remote-user to orient a local-user operating a camera.

### BACKGROUND

Handheld cameras such as smartphone cameras, and wearable cameras such as wrist-mounted or head-mounted cameras are popular. Streaming imaging content captured by such cameras is also developing fast. Therefore, a remote-user viewing in real-time imaging content captured by a camera operated by a local-user may provide instantaneous help to the local-user. Particularly, the remote-user may help the local-user to navigate in an urban area such as a street, a campus, a manufacturing facility, etc., including types of architectural structures such as malls, train stations, airports, etc. as well as any type of building, house, apartment such as a hotel, and many other situations.

One or more remote-users looking at captured pictures may see object of particular interest or importance that the person operating the camera may not see, or may not be aware of. The person operating the camera may not see such objects because he or she have a different interest, or because he or she does not see the pictures captured by the camera, or simply because the local-user is visually impaired. The remote-user may navigate the local-user through the immediate locality based on the imaging of the locality captured by the local-user in real-time.

However, current real-time image communication systems and real-time navigation systems are not designed to cooperate. Particularly, real-time image communication systems cannot navigate a person in any automatic manner, and navigation systems are cannot use imaging information in real-time. There is thus a widely recognized need for, and it would be highly advantageous to have, a system and method for remotely navigating a local-user manually operating a camera, devoid of the above limitations.

### SUMMARY OF THE INVENTION

According to one exemplary embodiment there is provided a method, a device, and a computer program for remotely navigating a local-user manually operating a mobile device associated with an imaging device such as a camera including: communicating in real-time, from an imaging device associated with the first user to a remote station, imaging data acquired by the imaging device, analyzing the imaging data in the remote station to provide actual direction of motion of the first user, acquiring by the remote station an indication of a required direction of motion of the first user, communicating the indication of a required direction of motion to a mobile device associated with the first user, and providing by the mobile device to the first user at least one humanly sensible cue, where the cue indicates a difference between the actual direction of motion of the first user and the indication of a required direction of motion.

According to another exemplary embodiment the mobile device may include the imaging device.

According to still another exemplary embodiment the direction of motion of the first user is visualized by the remote station to a user operating the remote station.

According to yet another exemplary embodiment the indication of a required direction of motion of the first user is acquired by the remote station from a user operating the remote station.

Further according to another exemplary embodiment the method, a device, and a computer program may additionally include: communicating the indication from the visualizing station to the imaging device, and/or calculating the motion difference between the actual direction of motion of the first user and the required direction of motion by the mobile device, and/or communicating the motion difference from the visualizing station to the imaging device.

Yet further according to another exemplary embodiment the method, a device, and a computer program may additionally include: acquiring by the remote station from the user a point of interest, calculating an imaging difference between actual orientation of the imaging device and the point of interest, and providing by the imaging device to the first user an indication of the imaging difference, where the imaging difference is adapted to at least one of: the difference between the actual direction of motion of the first user and the indication of a required direction of motion, and current location of the first user, and where the indication of imaging difference is humanly sensible.

Still further according to another exemplary embodiment the method, a device, and a computer program may additionally include: communicating the point of interest from the remote station to the imaging device, and/or calculating the imaging difference by the imaging device, and/or calculating the imaging difference by the remote station, and/or communicating the imaging difference from the visualizing station to the imaging device.

Even further according to another exemplary embodiment the remote station includes a software program to determine the required direction of motion.

Additionally, according to another exemplary embodiment the software program includes at least one of artificial intelligence, big-data analysis, and machine learning, to determine the point of interest.

According to yet another exemplary embodiment the artificial intelligence, big-data analysis, and/or machine learning, additionally includes: computing at least one correlation between the captured image and at least one of: a database of sceneries, and a database of scenarios, and determining the required direction of motion according to the at least one correlation, and/or determining the required direction of motion according to at least one of first user preference and second user preference associated with at least one correlation, and/or determining the cue according to a first user preference associated with the at least one correlation.

According to still another exemplary embodiment the system for remotely orienting a first user may include: a communication module communicating in real-time with a mobile device associated with the first user, receiving imaging data acquired by a imaging device associated with the mobile device, and communicating an indication of a required direction of motion of the first user to the mobile device, an analyzing module analyzing the imaging data to provide actual direction of motion of the first user, and an input module acquiring the indication of a required direction of motion of the first user, where the indication of a required direction of motion enables the mobile device to provide to the first user at least one humanly sensible cue, where the cue indicates a difference between the actual direction of motion of the first user and the indication of a required direction of motion.

Further according to another exemplary embodiment the mobile device for remotely orienting a first user, may include: a communication module communicating in real-time with a remote system communicating to the remote system imaging data acquired by a imaging device associated with the mobile device, and receiving from the remote system an indication of a required direction of motion of the first user; a motion analysis module providing actual direction of motion of the first user; and a user-interface module providing the first user at least one humanly sensible cue, wherein the cue indicates a difference between the actual direction of motion of the first user and the indication of a required direction of motion.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified is a simplified illustration of a remote-user-orientation system;

FIG. 2 is a simplified block diagram of a computing system used by remote-user-orientation system;

FIG. 3 a simplified illustration of a communication channel in the remote-user-orientation system;

FIG. 4 is a block diagram of remote-user-orientation system;

FIG. 5 is a simplified illustration of an exemplary locality, or scenery, and a respective group of images captured by a remotely assisted camera operated by a remotely assisted user;

FIG. 6 is a simplified illustration of a screen display of a remote viewing station showing the scenery as captured by the remotely assisted camera;

FIG. 7 is a simplified illustration of an alternative screen display of a remote viewing station;

FIG. 8 is a simplified illustration of local mobile device (camera) providing a visual cue;

FIG. 9 is a simplified illustration of a local mobile device (camera) providing a tactile cue;

FIG. 10 is a simplified flow-chart of remote-user-orientation software;

FIG. 11 is a simplified flow-chart of user-orientation module;

FIG. 12 is a simplified flow-chart of camera-control module; and

FIG. 13 is a block diagram of remote-user-orientation system including a remote artificial-intelligence software program.

### DETAILED DESCRIPTION

The present embodiments comprise systems and methods for remotely navigating a local-user manually operating a camera. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of the embodiments is to provide at least one system and/or method enabling a first, remote-user to remotely navigate a second, local, user manually operating a camera, typically without using verbal communication.

The terms “navigating a user” and/or “orienting a user” in this context may refer to a first user guiding, and/or navigating, and/or directing the movement or motion of a second user. For example, the first user may guide the walking of the second user (e.g., the walking direction), and/or the motion of a limb of the second user such as head or hand.

The first user may guide the second user based on images provided in real-time by a camera operated manually by the first user. It may be assumed that the second user is carrying and/or operating an imaging device (e.g., a camera). The term ‘operated manually’ or ‘manually operated’ may refer to the direction in which the camera is pointed. Namely, it is the second user that points the camera in a particular direction. The camera may be hand-held or wearable by the second user (e.g., on the wrist or on the head). It may also be assumed that the second user is visually restricted, and particularly unable to see the images captured by the camera.

The images captured by the camera are communicated to a remote viewing station operated by the first user. Based on these images, the first user may orient the second user. Particularly, the first user may indicate to the viewing station where the second user should move, and the camera, or a computing device associated with the camera, provide the second user with directional cues associated with the preferred direction as indicated by the first user.

It is appreciated that the second user may be replaced by a machine, or a computing system. The remote computing system (or imaging server) may use artificial intelligence (AI), and/or machine learning (ML), and/or big data (BD) technologies to analyze the images provided by the second user and/or provide guiding instructions to the second user, and/or assist the first user accordingly.

In this context, the term ‘image’ may refer to any type or technology for creating an imagery data, such as photography, still photography, video photography, stereo-photography, three-dimensional (3D) imaging, thermal or infra-red (IR) imaging, etc. In this context any such image may be ‘captured’, or ‘obtained’ or ‘photographed’.

The term ‘camera’ in this context refers to a device of any type or technology for creating one or more images or imagery data such as described herein, including any combination of imaging type or technology, etc.

The term ‘local camera’ refers to a camera (or any imaging device) obtaining images (or imaging data) in a first place and the terms ‘remote-user’ and ‘remote system’ or ‘remote station’ refer to a user and/or a system or station for viewing or analyzing the images obtained by the local camera in a second location, where the second location is remote from the first location. The term ‘location’ may refer to a geographical place or a logical location within a communication network.

The term ‘remote’ in this context may refer to the local camera and the remote station being connected by a limited-bandwidth network. For this matter the local camera and the remote station may be connected by a limited-bandwidth short-range network such as Bluetooth. The term ‘limited-bandwidth’ may refer to any network, or communication technology, or situation, where the available bandwidth is insufficient for communicating the high-resolution images, as obtained, in their entirety, and in real-time or sufficiently fast. In other words, ‘limited-bandwidth’ may mean that the resolution of the images obtained by the local camera should be reduced before they are communicated to the viewing station in order to achieve low-latency. It is appreciated that the system and method described herein is not limited to a limited-bandwidth network (of any kind), but that a limited-bandwidth network between the local device (camera) and remote device (viewing station or server) presents a further problem to be solved.

The terms ‘server’ or ‘communication server’ refer to any type of computing machine connected to a communication network to enabling communication between one or more cameras (e.g., a local camera) and one or more remote-users and/or remote systems.

The terms ‘network’ or ‘communication network’ refer to any type of communication medium, including but not limited to, a fixed (wire, cable) network, a wireless network, and/or a satellite network, a wide area network (WAN) fixed or wireless, including various types of cellular networks, a local area network (LAN) fixed or wireless, and a personal area network (PAN) fixes or wireless, and any combination thereof.

The terms ‘panorama’ or ‘panorama image’ refer to an assembly of a plurality, or collection, or sequence, of images (source images) arranged to form an image larger than any of the source images making the panorama. The term ‘particular image’ or ‘source image’ may refer to any single image of the plurality, or collection, or sequence of images from which the panorama image is made of.

The term ‘panorama image’ may therefore include a panorama image assembled from images of the same type and/or technology, as well as a panorama image assembled from images of different types and/or technologies. In the narrow sense, the term panorama may refer to a panorama image made of a collection of partially overlapping images, or images sharing at least one common object. However, in the broader sense, a panorama image may include images that do not have any shared (overlapping) area or object. A panorama may therefore include images partially overlapping as well as disconnected images.

The terms ‘register’, ‘registration’, or ‘registering’ refer to the action of locating particular features within the overlapping parts of two or more images, correlating the features, and arranging the images so that the same features of different images fit one over the other to create a consistent and/or continuous image, namely, the panorama. In the broader sense of the term panorama, the term ‘registering’ may also apply to the relative positioning of disconnected images.

The terms ‘panning’ or ‘scrolling’ refer to the ability of a user to select and/or view a particular part of the panorama image. The action of ‘panning’ or ‘scrolling’ is therefore independent of the form-factor, or field-of-view of any particular image from which the panorama image is made of. A user can therefore select and/or view a particular part of the panorama image made of two or more particular images, or parts of two or more particular images.

In this respect, a panorama image may use a sequence of video frames to create a panorama picture and a user may then pan or scroll within the panorama image as a large still picture, irrespective of the time sequence in which the video frames were taken.

The term ‘resolution’ herein, such as in high-resolution, low-resolution, higher-resolution, lower-resolution intermediate-resolution, etc., may refer to any aspect related to the amount of information associated to any type of image. Such aspects may be, for example:
Spatial resolution, or granularity, represented, for example, as pixel density or the number of pixels per area unit (e.g., square inch or square centimeter).
Temporal resolution, represented, for example, the number of images per second, or as frame-rate.
Color resolution or color depth, or gray level, or intensity, or contrast, represented, for example, as the number of bits per pixel.
Compression level or type, including, for example, the amount of data loss due to compression. Data loss may represent any of the resolution types described herein, such as spatial, temporal and color resolution.
Any combination thereof.

The term ‘resolution’ herein may also be known as ‘definition’, such as in high-definition, low-definition, higher-definition, intermediate-definition, etc.

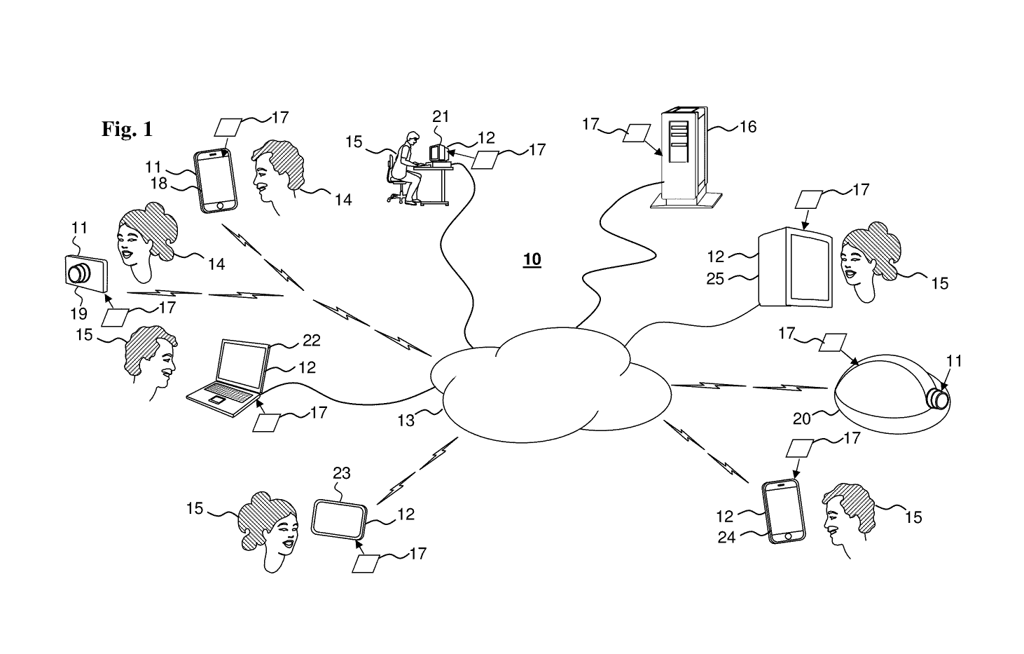

Reference is now made to FIG. 1, which is a simplified illustration of a remote-user-orientation system 10, according to one exemplary embodiment.

As shown in FIG. 1, remote-user-orientation system 10 may include at least one local user-orientation device 11 in a first location, and at least one remote viewing station 12 in a second location. A communication network 13 connects between local user-orientation device 11 and the remote viewing station 12. Local user-orientation device 11 may be operated by a first, local, user 14, while remote viewing station 12 may be operated by a second, remote, user 15. Alternatively or additionally, remote viewing station 12 may be operated by, or implemented as, a computing machine 16 such as a server, which may be named herein imaging server 16. Local user 14 may be referred to as local user, or as user 14. Remote user 15 may be referred to as remote user, or user 15.

Local user-orientation device 11 may be embodied as a portable computational device, and/or a hand-held computational device, and/or a wearable computational device. For example, the local user-orientation device 11 may be embodied as a mobile communication device such as a smartphone. Particularly, the local user-orientation device 11 may be equipped with an imaging device such as a camera. The term camera 11, or local camera 11, may refer to local user-orientation device 11 and vice versa. However, the local user-orientation device 11 may include separated computing device and camera, for example, as a mobile communication device and a head-mounted camera, or a mobile communication device and a smartwatch equipped with a camera, etc.

Communication network 13 may be any type of network, and/or any number of networks, and/or any combination of networks and/or network types, etc. Communication network 13 may be of ‘limited-bandwidth’ in the sense that the resolution of the images obtained by camera 11 should be reduced before the images are communicated to remote viewing station 12 in order for the images to be used in remote viewing station 12, or viewed by remote-user 15, in real-time and/or near-real-time and/or low-latency.

Local user-orientation device or camera 11 may include user-orientation software 17 or a part of user-orientation software 17. Remote viewing station 12 may also include user-orientation software 17 or a part of user-orientation software 17. Imaging server 16 may include user-orientation software 17 or a part of user-orientation software 17. Typically, user-orientation software 17 is divided into two parts, a first part executed by remote viewing station 12 or by a device associated with remote viewing station 12, such as Imaging server 16, and a second part executed by local user-orientation device 11, e.g., by camera 11, or by a device associated with local camera 11, such as a mobile computing device, such as a smartphone.

Local user-orientation device (or camera) 11 may include an imaging device capable of providing still pictures, video streams, three-dimensional (3D) imaging, infra-red imaging (or thermal radiation imaging), stereoscopic imaging, etc. and combinations thereof. Camera 11 can be part of a mobile computing device such as a smartphone (18). Camera 11 may be hand operated (19) or head mounted (or helmet mounted 20), or mounted on any type of mobile or portable device.

The remote-user-orientation system 10 and/or the user-orientation software 17 may include two functions: a camera-orientation function and a user navigation function. These functions may be provided and executed in parallel. These functions may be provided to the local-user 14 and/or to the remote-user 15 in the same time and independently of each other.

Regarding the camera-orientation function, the remote-user-orientation system 10 and/or the user-orientation software 17 may enable a remote-user 15 (using a remote viewing station 12) and/or an imaging server 16 to indicate to the system 10 and/or software 17 where the local-user should orient the camera 11 (point-of-interest). The system 10 and/or software 17 may then automatically and independently orient the local-user 14 to orient the camera 11 accordingly, capture the required image, and communicate the images to the remote viewing station 12 (and/or an imaging server 16).

Regarding the user navigation function, the remote-user-orientation system 10 and/or the user-orientation software 17 may enable a remote-user 15 (using a remote viewing station 12) and/or an imaging server 16 to indicate to the system 10 and/or software 17 a direction in which the local-user should move. And/or a target which the local-user should reach (motion vector). The system 10 and/or software 17 may then automatically and independently navigate the local-user 14 to move accordingly.

It is appreciated that the system 10 and/or software 17 may receive from the remote-user 15 (and/or an imaging server 16) instructions for both camera-orientation function and user navigation function, in substantially the same time, and independently of each other. It is appreciated that the system 10 and/or software 17 may provide to the local-user-orientation cues for both camera-orientation function and user navigation function, in substantially the same time, and independently of each other. It is appreciated that the combination of these functions provided in parallel is advantageous for both the local-user 14 and the remote-user 15.

The term ‘substantially the same time’ may refer to the remote-user 15 setting one or more points of interest for the camera-orientation function while the imaging server 16 is setting a motion vector for the user navigation function (and vice versa).

Alternatively or additionally the term ‘substantially the same time’ may refer to the remote-user 15 setting one or more points of interest for the camera-orientation function (or a motion vector) while the viewing station 12 is communicating a motion vector of the user navigation function (or a point of interest) to the local user-orientation device 11.

Alternatively or additionally the term ‘substantially the same time’ may refer to the remote-user 15 setting one or more points of interest or a motion vector while the local user-orientation device 11 is orienting the user (for any of other point of interest or a previously set motion vector).

Alternatively or additionally the term ‘substantially the same time’ may refer to the local user-orientation device 11 orienting the user to point the camera at a particular point of interest and at the same time move according to a particular motion vector.

It is appreciated that remote user-orientation system 10 may execute these processes, or functions, in real-time or near-real-time. However, remote user-orientation system 10 may also enable these processes, or functions, in off-line or asynchronously, in the sense that once user 15 has set a motion vector and/or a point-of-interest, user 15 needs not be involved in the actual guiding of the user to move accordingly or to orient the camera accordingly. This, for example, is particularly useful with panorama imaging where the area of the panorama image is much larger than the area captured by local camera 11 in a single image capture.

Remote user-orientation system 10 may also include, or use, a panorama processing system. The panorama processing system enables the remote viewing station 12 to create in real-time, or near real-time, an accurate panorama image from a plurality of partially overlapping low-resolution images received from local camera 11.

Panorama processing system may include or use a remote resolution system enabling the remote viewing station 12 to request and/or receive from local camera 11 high-resolution (or higher-resolution) versions of selected portions of the low-resolution images. This, for example, enables remote viewing station 12 to create in real-time, or near real-time, an accurate panorama image from the plurality of low-resolution images received from local camera 11.

More information regarding possible processes and/or embodiments of a panorama processing system may be found in PCT applications WO/2017/118982 and PCT/IL2017/050213, which are incorporated herein by reference in its entirety.

Remote viewing station 12 may be any computing device such as a desktop computer 21, a laptop computer 22, a tablet or PDA 23, a smartphone 24, a monitor 25 (such as a television set), etc. Remote viewing station 12 may include a (screen) display for use by a remote second user 15. Each remote viewing station 12 may include a remote-resolution remote-imaging module.

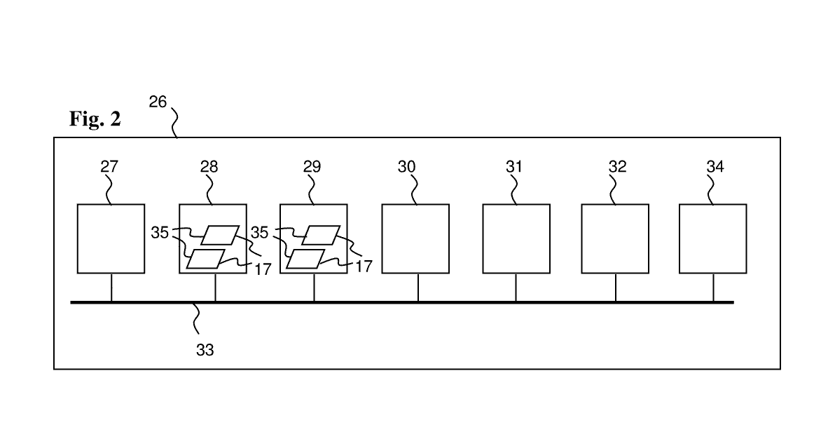

Reference is now made to FIG. 2, which is a simplified block diagram of a computing system 26, according to one exemplary embodiment. As an option, the block diagram of FIG. 2 may be viewed in the context of the details of the previous Figures. Of course, however, the block diagram of FIG. 2 may be viewed in the context of any desired environment. Further, the aforementioned definitions may equally apply to the description below.

Computing system 26 is a block diagram of a computing system, or device, 26, used for implementing a camera 11 (or a computing device hosting camera 11 such as a smartphone), and/or a remote viewing station 12 (or a computing device hosting remote viewing station 12), and/or an imaging server 16 (or a computing device hosting imaging server 16). The term ‘computing system’ or ‘computing device’ refers to any type or combination of computing devices, or computing-related units, including, but not limited to, a processing device, a memory device, a storage device, and/or a communication device.

As shown in FIG. 2, computing system 26 may include at least one processor unit 27, one or more memory units 28 (e.g., random access memory (RAM), a non-volatile memory such as a Flash memory, etc.), one or more storage units 29 (e.g. including a hard disk drive and/or a removable storage drive, representing a floppy disk drive, a magnetic tape drive, a compact disk drive, a flash memory device, etc.). Computing system 26 may also include one or more communication units 30, one or more graphic processors 31 and displays 32, and one or more communication buses 33 connecting the above units.

In the form of camera 11, computing system 26 may also include one or more imaging sensors 34 configured to create a still picture, a sequence of still pictures, a video clip or stream, a 3D image, a thermal (e.g., IR) image, stereo-photography, and/or any other type of imaging data and combinations thereof.

Computing system 26 may also include one or more computer programs 35, or computer control logic algorithms, which may be stored in any of the memory units 28 and/or storage units 29. Such computer programs, when executed, enable computing system 26 to perform various functions (e.g. as set forth in the context of FIG. 1, etc.). Memory units 28 and/or storage units 29 and/or any other storage are possible examples of tangible computer-readable media. Particularly, computer programs 35 may include remote orientation software 17 or a part of remote orientation software 17.

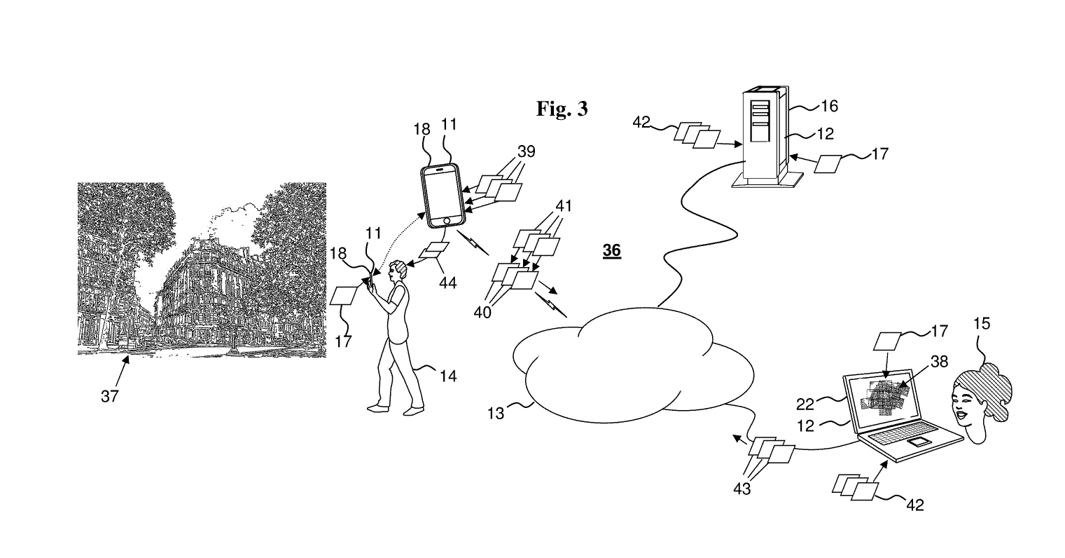

Reference is now made to FIG. 3, which is a simplified illustration of a communication channel 36 for communication panorama imaging, according to one exemplary embodiment. As an option, the illustration of FIG. 3 may be viewed in the context of the details of the previous Figures. Of course, however, the illustration of FIG. 3 may be viewed in the context of any desired environment. Further, the aforementioned definitions may equally apply to the description below.

As shown in FIG. 3, communication channel 36 may include a camera 11 typically operated by a first, local, user 14 and a remote viewing station 12, typically operated by a second, remote, user 15. Camera 11 and remote viewing station 12 typically communicate over communication network 13. Communication channel 36 may also include imaging server 16. Camera 11, and/or remote viewing station 12, and/or imaging server 16 may include computer programs 35, which may include remote orientation software 17 or a part of remote orientation software 17.

As shown in FIG. 3, user 14 may be located in a first place photographing surroundings 37, which may be outdoors, as shown in FIG. 3, or indoors. User 15 may be located remotely, in a second place, watching one or more images captured by camera 11 and transmitted by camera 11 to remote viewing station 12. In the example shown in FIG. 3 viewing station 12 displays to user 15 a panorama image 38 created from images taken by camera 11 operated by user 14.

As an example user 14 may be a visually impaired person out in the street, in a mall, or in an office building and have orientation problems. User 14 may call for assistance of a particular user 15, who may be a relative, or may call a help desk which may assign an attendant of a plurality of attendants currently available. As shown and described with reference to FIG. 1, user 15 may be using a desktop computer with a large display, or a laptop computer, or a tablet, or a smartphone, etc.

As another example of the situation shown and described with reference to FIG. 3, user 14 may be a tourist traveling in a foreign country and being unable to read signs and orient himself appropriately. As another example, user 14 may be a first responder or a member of an emergency force. For example, user 14 may stick his hand with camera 11 into a space and scan it so that another member of the group may view the scanned imagery. For this matter, users 14 and 15 may be co-located.

It is appreciated that remote-user-orientation system 10 may be useful for any local-user when required to maneuver or operate in an unfamiliar locality or situation thus requiring instantaneous remote assistance (e.g., an emergency situation) which may require the remote user to have a direct real-time view of the scenery.

A session between a first, local, user 14 and a second, remote, user 15 may start by the first user 14 calling the second user 15 requesting help, for example, navigating or orienting (finding the appropriate direction). In the session, the first user 14 operates the camera 11 and the second user 15 views the images provided by the camera and directs the first user 14.

A typical reason for the first user to request the assistance of the second user is a difficulty seeing, and particularly a difficulty seeing the image taken by the camera. Such reason is that the first user is visually impaired, or being temporarily unable to see. The camera display may be broken or stained. The first user's glasses, or a helmet protective glass, may be broken or stained. The user may hold the camera with the camera display turned away or with the line of sight blocked (e.g., around a corner). Therefore, the first user does not see the image taken by the camera, and furthermore, the first user does not know where exactly the camera is directed. Therefore, the images taken by the camera 11 operated by the first user 14 are quite random.

The first user 14 may call the second user 15 directly, for example by providing camera 11 with a network identification of the second user 15 or the remote viewing station 12. Alternatively, the first user 14 may request help and the distribution server (not shown) may select and connect the second user 15 (or the remote viewing station 12). Alternatively, the second user 15, or the distribution server may determine that the first user 14 needs help and initiate the session. Unless specified explicitly, a reference to a second user 15 or a remote viewing station 12 refers to an imaging server 16 too.

Typically, first user 14 operating camera 11, may take a plurality of images, such as a sequence of still pictures or a stream of video frames. Alternatively, or additionally, first 14 may operate two or more imaging devices, which may be embedded within a single camera 11, or implemented as two or more devices, all referenced herein as camera 11. Alternatively, or additionally, a plurality of first users 14 operating a plurality of cameras 11 may take a plurality of images.

Camera 11 may take a plurality of high-resolution images 39, store the high-resolution images internally, convert the high-resolution images into low-resolution images 40, and transmit the plurality of low-resolution images 40 to viewing station 12, typically by using remote orientation software 17 or a part of remote orientation software 17 embedded in cameras 11. Each of images 40 may include, or be accompanied by, capture data 41.

Capture data 41 may include information about the image such as the position (location) of the camera when the particular image 40 has been captured, the orientation of the camera, optical data such as type of lens, shutter speed, iris opening, etc. Camera position (location) may include GPS (global positioning system). Camera-orientation may include three-dimensional, or six degrees of freedom information, regarding the direction in which the camera is oriented. Such information may be measured using an accelerometer, and/or a compass, and/or a gyro. Particularly, camera-orientation data may include the angle between the camera and the gravity vector.

The plurality of imaging devices herein may include imaging devices of different types, or technology, producing images of different types, or technologies, as disclosed above (e.g., still, photography, video, stereo-photography, 3D imaging, thermal imaging, etc.).

Alternatively, or additionally, the plurality of images is transmitted by one or more cameras 11 to an imaging server 16 that may then transmit images to viewing station 12 (or, alternatively, viewing station 12 may retrieve images from imaging server 16).

Viewing station 12 and/or imaging server 16, may then create a one or more panorama images 42 from any subset plurality of images of the plurality of low-resolution images 40. Viewing station 12 may retrieve panorama images 42 from imaging server 16.

Viewing station 12 and/or imaging server 16, may then analyze the differences between recent images and the panorama image (38, 42) and capture data 41 to determine the direction and speed in which local-user 14 (as well as camera 11) is moving. Viewing station 12 may then display an indication of the direction and/or speed on the display of viewing station 12.

Remote-user 15, using viewing station 12, may then indicate a required direction, in which local-user 14 should move. Viewing station 12, may then send to camera 11 (or computing system 26 hosting, or associated with, local camera 11) a required direction indication 43.

Camera 11 (or computing system 26 hosting, or associated with, local camera 11) may then receive required direction indication 43 and provide local-user 14 with one or more cues 44, guiding local-user 14 in the direction indicated by required direction indication 43.

The process of capturing images (by the camera), creating a panorama image, analyzing the direction of motion of the local-user, displaying an indication of the direction of motion, indicating required direction of motion, and sending the required direction indication to the camera, (by the remote viewing station), and providing a cue to the local-user to navigate the local-user according to the required direction indication (by the camera) may be repeated as needed. It is appreciated that this processes is performed substantially in real-time.

Additionally, and/or optionally, remote-user 15, using viewing station 12, may also indicate a point or an area associated with panorama image 38, for which he or she requires capturing one or more images by camera 11. Remote viewing station 12, may then send one or more image capture indication data (not shown in FIG. 3) to camera 11. Camera 11 may then provide one or more cues (not shown in FIG. 3) to local-user 14, the cues guiding user 14 to orient camera 11 in the direction required to capture the image (or images) as indicated by remote-user 15, and to capture the desired images.

Thereafter, camera 11 may send (low-resolution) images 40 (with their respective capture data 41) to remote viewing station 12, which may add these additional images in the panorama image (38, and/or 42).

The process of capturing images (by the camera), creating a panorama image, indicating required additional images (by the remote viewing station), capturing the required images, and sending the images to the remote viewing station (by the camera), and updating the panorama image with the required images (by the remote viewing station), may be repeated as needed. It is appreciated that this processes is performed substantially in real-time.

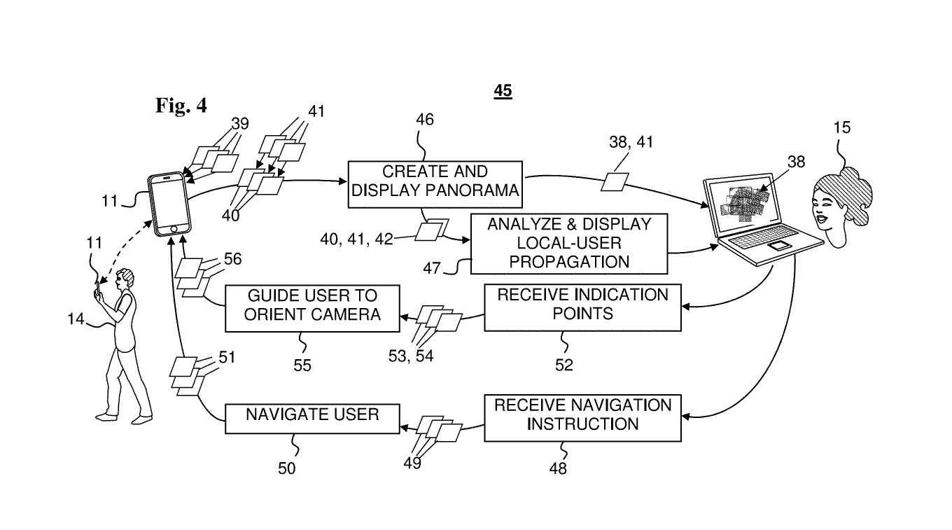

Reference is now made to FIG. 4, which is a block diagram of an orientation process 45 executed by remote-user-orientation system 10, according to one exemplary embodiment.

As an option, the block diagram of orientation process 45 of FIG. 4 may be viewed in the context of the details of the previous Figures. Of course, however, block diagram of orientation process 45 of FIG. 4 may be viewed in the context of any desired environment. Further, the aforementioned definitions may equally apply to the description below.

Orientation process 45 may represent a process for orienting a user or a camera by remote user-orientation system 10 in a communication channel 36 as shown and described with reference to FIG. 3. As shown in FIG. 4, the orientation process 45 executed by remote user-orientation system 10 includes the following main sub-processes:

A. Camera 11 operated by local-user 14 may capture high-resolution images 39, convert the high-resolution images into low-resolution images 40, and send the low-resolution images 40 together with their respective capture data 41 to remote viewing station 12 (and/or imaging server 16). Panorama process 46, typically executing in remote viewing station 12 (and/or imaging server 16), may then receive images 40 and their capture data 41, and create (one or more) panorama images 42.

B. Remote viewing station 12 may then display a panorama image 38 (any of panorama images 42) to remote-user 15. Propagation analysis module 47 may then use images 40 and their capture data 41, to analyze the motion direction and speed of local-user 14 with respect to panorama image 38. Propagation analysis module 47 may then display on panorama image 38 an indication of the motion direction and speed of local-user 14. Propagation analysis module 47 is typically executing in remote viewing station 12. Additionally or alternatively, propagation analysis module 47 may be executed in or by imaging server 16.

C. Navigation indication process 48 (typically executing in remote viewing station 12), may then receive from user 15 an indication of the direction in which local-user 14 should move. Additionally or alternatively, navigation indication process 48 may be executed in or by imaging server 16 and determine the direction in which local-user 14 should move using, for example, artificial intelligence (AI) and/or machine learning (ML) and/or big-data (BD) technologies. Navigation indication process 48, may then send a required direction indication 49 (typically equivalent to required direction indication 43 of FIG. 3) to camera 11 (or computing system 26 hosting, or associated with, local camera 11).

D. Local avigation process 50 (typically executing in camera 11 (or computing system 26 hosting, or associated with, local camera 11) may then receive required direction indication 49 and provide local-user 14 with one or more user-sensible cues 51, guiding local-user 14 to move in the direction indicated by required direction indication 49.

E. Optionally, a remote camera-orientation process 52 (also typically executing in remote viewing station 12) may receive from user 15 one or more indication points 53 and/or indication areas 54 indicating one or more points of interest where user 15 requires more images.

User 15 may indicate an indication point 53 and/or indication area 54 in one of a plurality of modes such as absolute mode and relative mode. In absolute mode, the indication point 53 and/or indication area 54 indicates an absolute point or area in space. In relative mode, the indication point 53 and/or indication area 54 indicates a point or area with respect to the user, or the required orientation of the camera with respect to the required direction indication 49, and combinations thereof.

Additionally or alternatively, the remote camera-orientation process 52 may be executed in or by imaging server 16 and determine indication points using, for example, AI, ML and/or BD technologies.

F. A local camera-orientation process 55, typically executing in camera 11 or a computing device hosting camera 11 such as a smartphone, may then receive from remote camera-orientation process 52 one or more indication points 53 and/or indication areas 54 and queue them. Local camera-orientation process 55 may then guide user 14 to orient camera 11 to capture the required images as indicated by each and every indication points 53 and/or indication areas 54, one by one. Local camera-orientation process 55 may guide user 14 to orient camera 11 at the required direction by providing user 14 with a one or more user-sensible cues 56. It is appreciated that sub-processes 52 and 55 may be optional.

Any two or more of sub-processes 46, 47, 48, and 50, as well as optional sub-processes 52 and 55 may be executed in parallel. For example, navigation processes 46, 47, 48, and 50 may direct local-user 14 in the required direction, while camera-orientation processes (46, 47) 52 and 55 may guide user 14 to capture new images 39. It is appreciated that camera-orientation processes 48 and 50 may orient camera 11 in a different direction than the direction of motion in which navigation process 53 may guide local-user 14. It is appreciated that navigation processes 48, and 50 may direct local-user 14 to a position or location from where capturing the required image is possible and/or optimal and/or preferred (e.g., by the remote user 15).

In the same time, panorama process 46 may receive new images 40 captured by camera 11, and generate new panorama images 38 from any collection of previously captured images 40. While panorama process 46 displays one or more images 40 and/or a panorama images 38, the propagation analysis module 47 may analyze the developing panorama image and display an indication of the direction of motion of user 14. In the same time, navigation indication process 48 may receive from user 15 new direction indications, and send new required direction indication 49 to camera 11. In the same time, remote camera-orientation process 52 may receive from user 15 more indication points 53 and/or indication areas 54.

It is appreciated that any of sub-processes 46, 47, 48, and 50, as well as 52 and 55, may be at least partially executed by imaging server 16 and/or by any of artificial intelligence (AI) and/or machine learning (ML) and/or big-data (BD) technologies.

It is appreciated that the measure of difference between the current camera-orientation and the required camera-orientation may be computed as a planar angle, a solid angle, a pair of Cartesian angles, etc. The cue provided to the user may be audible, visual, tactile and verbal, or combinations thereof. A cue representing a two-dimensional value such as a solid angle, a pair of Cartesian angles, etc., may include two or more cues, each representing or associated with a particular dimension of the difference.

It is appreciated that the cue 51 and/or 56 provided to user 14 may include a magnitude, or an amplitude, or a similar value, representing the difference between the current direction of motion of the user and the required direction of motion of the user, as well as the current camera-orientation and the required camera-orientation.

The difference may be provided to the user in a linear manner, such as a linear ratio between the cue and the abovementioned difference. Alternatively, the difference may be provided to the user in a non-linear manner, such as a logarithmic ratio between the cue and the abovementioned difference (e.g., a logarithmic value of the difference).

For example, the angle between the actual direction of motion (or direction in which the camera is pointed) and the required direction of motion (or camera) can be represented for example by audio frequency (pitch). In a linear mode one degree can be represented by, for example, 10 Hz, so that an angle of 90 degrees may be represented by 900 Hz, an angle of 10 degrees may be represented by 90 Hz and an angle of 5 degrees may not be heard. In non-linear mode, for example, an angle of 90 degrees may be represented by 900 Hz, an angle of 10 degrees may be represented by 461 Hz, and an angle of 2 degrees may be represented by 139 Hz.

Therefore, a non-linear cue may indicate a small difference more accurately than a large difference. In other words, a non-linear cue may indicate a small difference in higher resolution than a linear cue.

The magnitude of cue 51 and/or 56 may include amplitude and/or pitch, or frequency of an audible signal, or brightness of light, or color, or the position of a symbol such as cross-hair, etc., a pulsed signal where the pulse repetition rate represents the magnitude of the difference, etc., and combinations thereof.

Cue 51 and/or 50 may include a combination of cues indicating a difference in two or three dimensions. For example, one cue indicating a horizontal difference and the other cue indicating a vertical difference.

A tactile signal may comprise four different tactile signals each representing a different difference value between the current camera-orientation and the required camera-orientation, for example, respectively associated with up, down, left and right differences.

It is appreciated that cues 51 and 56 may use different types of cues, whether audible cues of different frequencies, or cues oriented at different senses. For example, cues 51 may direct the user motion using audible cues while cue 50 may orient the camera using tactile cues.

It is appreciated that audible cues may include any type of sound and/or speech, and/or acoustic signal that a human may hear or is otherwise sensible to the local-user. Tactile cues may include any type of effect that a user may feel, particularly by means of the user skin, such as pressure and/or vibration. Other types of humanly sensible effects are also contemplated, such as blinking and/or colors.

It is appreciated that, when camera 11 is oriented as required, local camera-orientation process 55 may provide local-user 14 with a special cue instructing local-user 14 to capture an image. Alternatively, local camera-orientation process 55 may trigger the camera to capture an image directly, or automatically, or autonomously.

Images captured using camera-orientation processes 52 and 55 may be combined to create a panorama image. The panorama image may be used by the remote-user to determine missing parts, and/or images, and/or objects, and/or lack of sufficient details, which may require further image capture. The panorama image may be used by the remote-user to create indications of such points and/or areas of interest.

The creating of an accurate panorama image requires details that may not be provided in the low-resolution images communicated via the limited-bandwidth network connecting the camera and the remote viewing station. To receive high-resolution image portion enabling accurate registration of the mages making the panorama image the panorama processing system may use a remote resolution system.

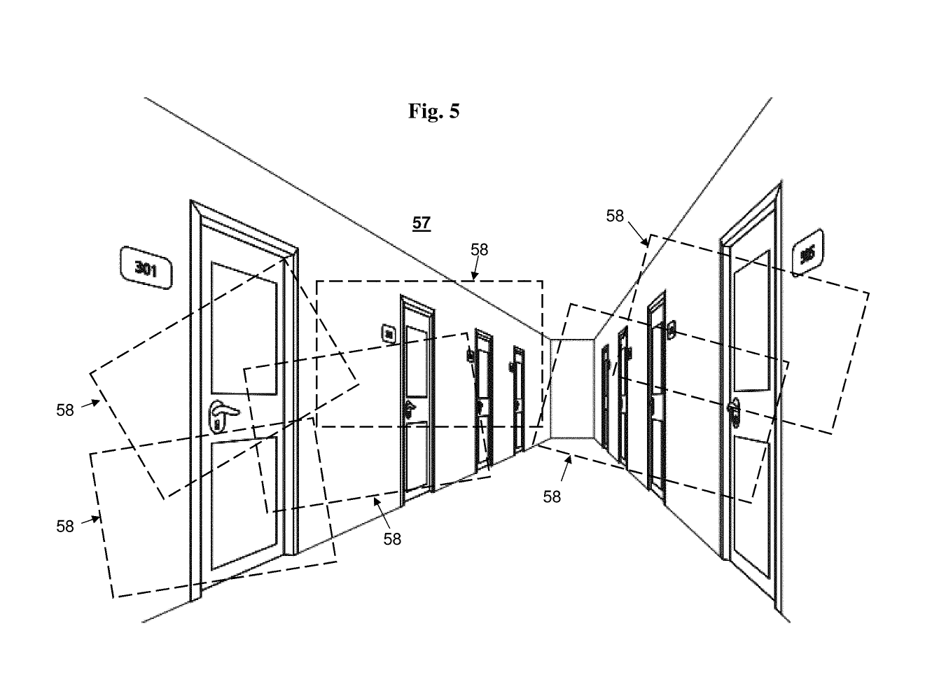

Reference is now made to FIGS. 5, which is a simplified illustration of an exemplary locality, or scenery, and a respective group of images captured by a remotely assisted camera operated by a remotely assisted user, according to one exemplary embodiment.

As an option, the illustration of FIG. 5, may be viewed in the context of the details of the previous Figures. Of course, however, illustration of FIG. 5 may be viewed in the context of any desired environment. Further, the aforementioned definitions may equally apply to the description below.

In the example of FIG. 5, the local (remotely assisted) user is walking up a hotel corridor 57 seeking a particular room according to the room number. FIG. 5 shows the hotel corridor and a number of pictures 58 of the hotel corridor as captured by the camera carried by the local-user.

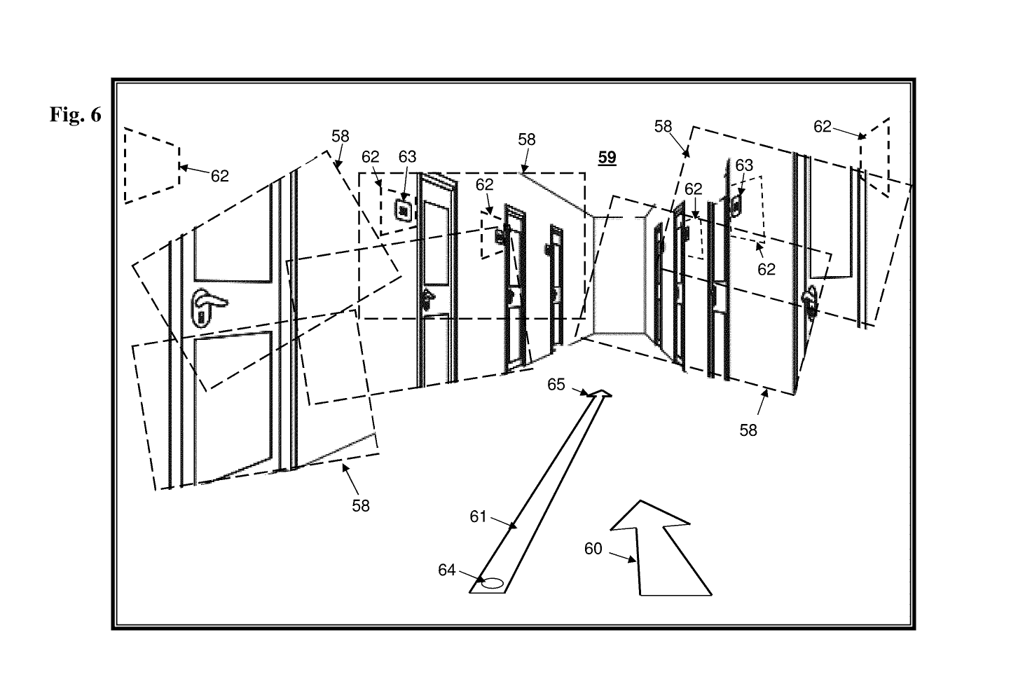

Reference is now made to FIG. 6, which is a simplified illustration of a screen display of a remote viewing station, according to one exemplary embodiment.

As an option, the screen illustration of FIG. 6 may be viewed in the context of the details of the previous Figures. Of course, however, the screen illustration of FIG. 6 may be viewed in the context of any desired environment. Further, the aforementioned definitions may equally apply to the description below.

As shown in FIG. 6, the screen of the remote viewing station displays a panorama image 59, made from images 58 captured by the camera carried by the local-user, as shown and described with reference to FIG. 5. It is appreciated that image 59, which in FIG. 6 is a panorama image, may be any kind of image, including an image based on a single picture. On the other hand, image 59 may be based on a sequence of still pictures, and/or a video stream, and/or a collection of selected frames from a video stream and/or a collection of images captured by different imaging technologies as described above.

The screen of the remote viewing station 12 also displays a sign 60, such as an arrow, indicating the motion direction of the local-user. Using an input device of the remote viewing station, such as a pointing device (e.g., a mouse), the remote-user 15 may create a required motion vector indicator 61, such as an arrow displayed on the screen. The required motion vector indicator 61 points in the direction that the local-user 14 should move.

Alternatively, when, for example, the remote viewing station 12 is a hand-held device such as a smartphone, the remote-user 15 may use the remote viewing station 12 as its pointing device. For example, the remote-user 15 may tilt or rotate the remote viewing station 12 to point the remote viewing station 12 in the in the direction that the local-user 14 should move. For example, the remote-user 15 may tilt or rotate the remote viewing station 12 so that the direction in which the local-user 14 should move is at the center of the screen display, and optionally click a button or tap on the screen to set and/or send the direction indication 49. In the same manner that remote-user 15 may set and/or send the indication point 53 and/or indication area 54. It is appreciated that remote-user 15 may freely alternate between setting and/or sending the direction indication 49 and the indication point 53 and/or indication area 54.

Using an input device of the remote viewing station, such as a pointing device (e.g., a mouse), the remote-user 15 may also indicate one or more points, or areas, of interest 62, such as the areas containing the room numbers 63. The points, or areas, of interest 62 indicate to the remote viewing station points, or areas, that should for which the camera used by the local-user should capture respective images.

The remote-user 15 may also indicate that a particular point, or area, of interest 62 is repetitive (e.g., such as the areas containing the room numbers 63). Thus, as the local-user 14 moves along the motion vector, the remote viewing station 12 automatically generates the next indication point 53 and/or indication area 54, for example, by means of AI, ML and/or BD technology. For example, the remote viewing station 12 automatically studies repetitive features of the scenery and correlates an object within the indication point 53 and/or indication area 54 with other repetitive objects or structures to automatically locate the next indication point 53 and/or indication area 54.

As shown in FIG. 6, the remote viewing station 12 displays an indicator 61 of the required direction of motion for the local-user. Indicator 61 indicates a three-dimensional (3D) vector displayed on a two-dimensional image, using a two-dimensional screen display. The remote viewing station enables the remote-user to locate and orient a 3D indicator 61 in virtual 3D space.

For example, the remote viewing station may automatically identify the bottom surface (e.g., the floor) shown in image 59. For example, the remote viewing station may automatically identify the vanishing point of image 59 and determine the bottom surface according to the vanishing point. The remote-user may first locate on image 59 a point of origin 64 of indicator 61, and then pull an arrow head 65 of indicator 61 in the required direction. The remote viewing station may then automatically attach indicator 61 to the bottom surface. The remote-user may than pull the arrow head left or right as required. Indicator 61 may then automatically follow the shape, and/or orientation, of the bottom surface. It is appreciated that the bottom surface may be slanted, as in a staircase, a slanted ramp, etc.

It is appreciated that the arrow head 65 may mark the end (e.g., a target position) of the intended motion of the local-user. In such case, when reaching the target position, camera 11 (or a computing device hosting camera 11 such as a smartphone), may signal to the user that the target position has been reached.

Alternatively, a second indicator 61 may be provided by the remote-user, with the point of origin of the second indicator 61 associated with the arrow head 65 of the first indicator 61, to create a continuous travel of the local-user along the connected indicators 61.

It is appreciated that remote-user-orientation system 10 may enable the remote-user to indicate a plurality of indicators 61 of the required direction of motion for the local-user. For example, if the local-user should turn around a corner, the remote-user may create a sequence of two or more indicators 61 of the required path of the local-user. The remote viewing station may then enable the remote-user to combine the two (or more) successive indicators 61 into a single, continuous (or contiguous) indicator 61.

If, for example, image 59 may include a plurality of vanishing points, a plurality of indicators 61 may refer, each, to a different vanishing point. In such case the vanishing point selected for a particular indicator 61 is the vanishing point associated with both origin 64 and arrow head 65 of the particular indicator 61. Therefore, a sequence of required motion vector indicators 61 may each relate to a different (local) vanishing point, and hence attach to a local bottom surface. It is appreciated that the term ‘bottom surface’ may refer to any type of surface and/or to any type of motion platform.

Reference is now made to FIG. 7, which is a simplified illustration of an alternative screen display of a remote viewing station, according to one exemplary embodiment.

As an option, the screen illustration of FIG. 7 may be viewed in the context of the details of the previous Figures. Of course, however, the screen illustration of FIG. 7 may be viewed in the context of any desired environment. Further, the aforementioned definitions may equally apply to the description below.

As shown in FIG. 7, the remote-user may use an input device of the remote viewing station, such as a pointing device, to create one or more indicators 66 of points of interest, such as the room numbers 63. However, the indicator, using, for example, an arrow, also defines the angle at which the required image should be captured.

Alternatively, or additionally, the remote-user may indicate on the indicator 61 one or more capturing points 67, wherefrom a particular image should be captured, such as an image indicated by indicator 66.

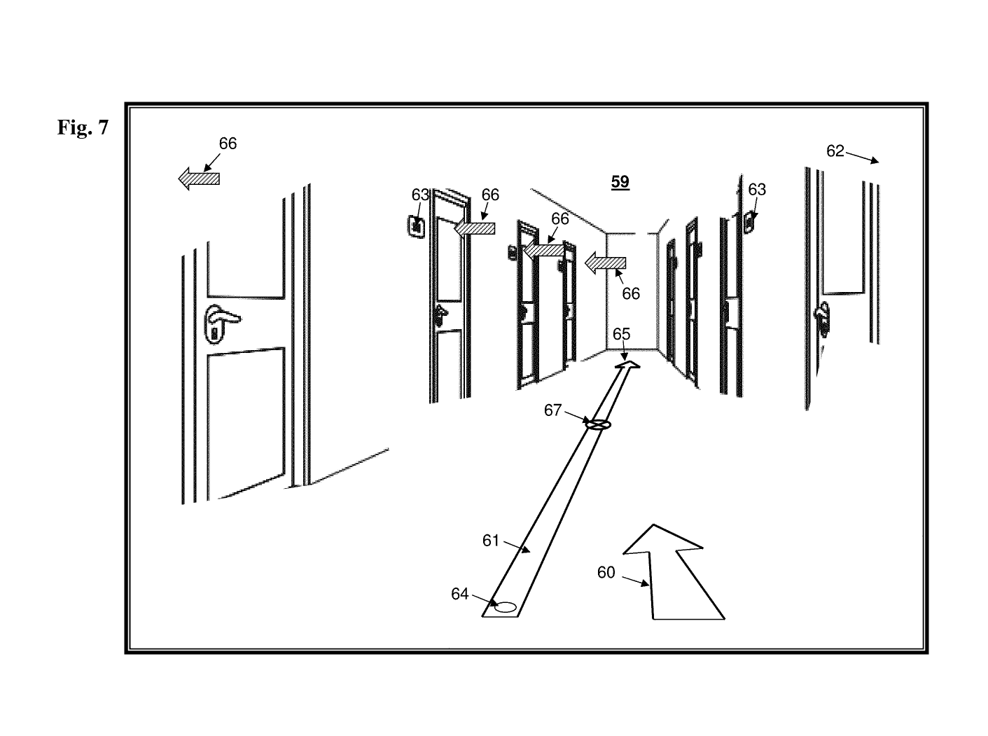

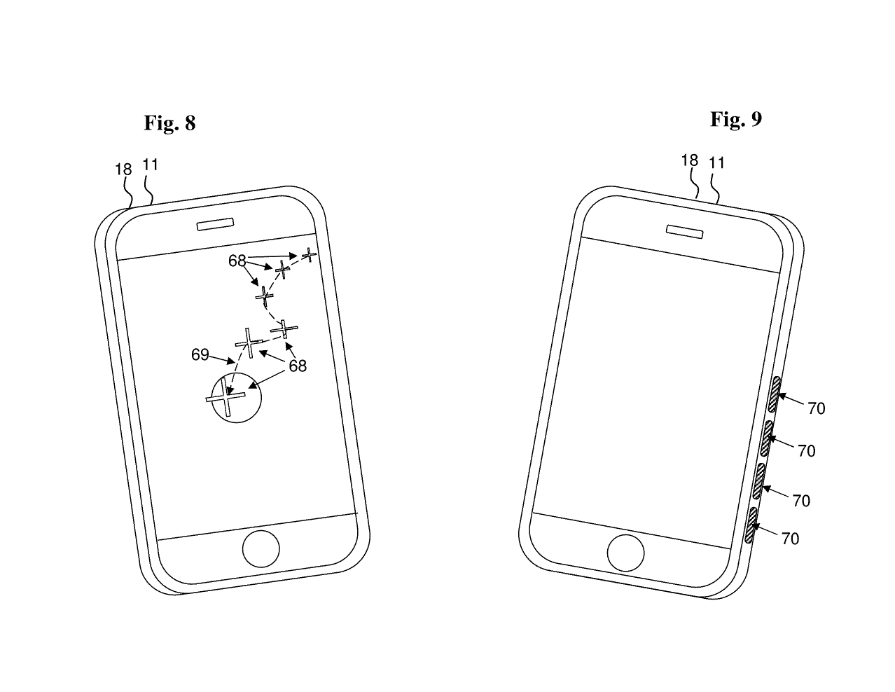

Reference is now made to FIG. 8, which is a simplified illustration of local camera 11 providing a visual cue 68, according to one exemplary embodiment.

As an option, the visual cue of FIG. 8 may be viewed in the context of the details of the previous Figures. Of course, however, the visual cue of FIG. 8 may be viewed in the context of any desired environment. Further, the aforementioned definitions may equally apply to the description below.

As shown in FIG. 8, camera 11 is provided as, or embedded in, a smartphone or a similar device equipped with a display. As shown in FIG. 8, visual cue 68 may be provided on the display as, for example, a cross-hair or a similar symbol. Visual cue 68 may change its location on the screen, as well as its size and aspect ratio, according to the angle between the current orientation of the user and the required motion vector, and/or the distance between the local user and the destination point 65 or 67. Similarly, the visual cue may change its location on the screen, as well as its size and aspect ratio, according to the angle between the current orientation of local camera 11 and the required orientation and/or the distance between the camera and the point of interest.

FIG. 8 shows several visual cues 68 as seen by user 14 as user 14 moves along a desired path, as indicated by broken line 69, until, for example, the user arrives at a destination point 65 or 67, or, as user 14 moves local camera 11 along a desired path, as indicated by broken line 69, until, for example, local camera 11 is oriented at the required direction.

Alternatively, if user 14 cannot see details (such as a cross-hair) displayed on the screen of local camera 11, the display or a similar lighting element may be used in a manner similar to the acoustic cues described above, namely any combination of frequency (pitch, e.g. color) and pulse rate that may convey an estimate of the angle, or angles, between the current orientation of the local user 14 or the local camera 11 and the required orientation.

Reference is now made to FIG. 9, which is a simplified illustration of a local camera 11 providing a tactile cue, according to one exemplary embodiment.

As an option, FIG. 9 may be viewed in the context of the details of the previous Figures. Of course, however, FIG. 9 may be viewed in the context of any desired environment. Further, the aforementioned definitions may equally apply to the description below.

FIG. 9 shows a local camera 11 embodied, for example, in a smartphone of a similar hand-held device. As shown in FIG. 9 local camera 11 may have two or four tactile actuators 70, which may correspond to the position of two or four fingers holding local camera 11. Other numbers of tactile actuators, and other uses of such actuators (e.g., instead of fingers) are also contemplated. For example, actuators may be positioned on one or more bands on the user's wrists or in any other wearable device.

Each tactile actuator 70 may produce a sensory output that can be distinguished by the user, for example, by a respective finger. A tactile actuator 70 may include a vibrating motor, a solenoid actuator, a piezoelectric actuator, a loudspeaker, etc.

Tactile actuator 70 may indicate to the local-user a direction of motion (in which two actuators indicating left or right may be sufficient) and/or a direction in which the local camera 11 should be oriented (in which four actuators may be required, indicating up, down, left, and right). A pulse repetition rate of the tactile cue may represent the angle between the current orientation and the required orientation.

When local-user 14 orients of local camera 11 as required by the respective indication data (53, 54, or point of interest 62 or 66), local camera 11 may capture the required image automatically or manually. Thereafter, local camera 11, and/or the respective part of remote orientation software 17, may automatically proceed to the next indication data (or point of interest).

Similarly, when the motion vector indicator includes a sequence of required motion vector indicators 61, and the local-user reaches the end of one motion vector indicator 61, local camera 11 may automatically continue to the next motion vector indicator 61.

It is appreciated that local camera 11, and/or a computing device associated with local camera 11 (such as a smartphone), may use any type of cue (e.g., visual cue, audible cue, and tactile cue) to indicate to the local-user the required direction of motion, or the required camera-orientation.

It is appreciated that local camera 11, and/or a computing device associated with local camera 11 (such as a smartphone), may use any combination of types of cue (e.g., visual cue, audible cue, and tactile cue) to indicate to the local-user the required direction of motion, and the required camera-orientation, substantially in the same time. For example, local camera 11 (and/or a computing device associated with local camera 11) may use tactile cues to indicate required direction of motion, and, simultaneously, use audible cues to indicate required camera-orientation. The term ‘substantially in the same time’ here also includes alternating repeatedly between camera-orientation and motion orientation.

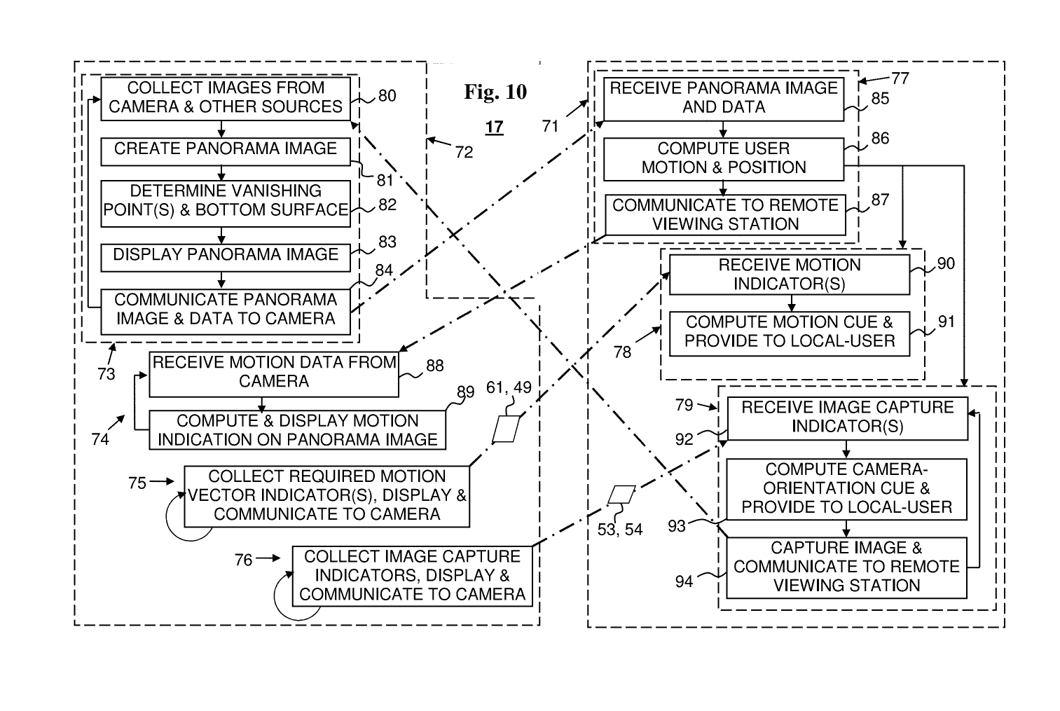

Reference is now made to FIG. 10, which, is a simplified flow-chart of remote-user-orientation software 17, according to one exemplary embodiment.

As an option, the flow-chart of FIG. 10 may be viewed in the context of the details of the previous Figures. Of course, however, the flow-chart of FIG. 10 may be viewed in the context of any desired environment. Further, the aforementioned definitions may equally apply to the description below.

As shown in FIG. 10, user-orientation software 17 includes several modules arranged into parts of user-orientation software 17. A local part 71 may be executed by local camera 11, and/or a computing device associated with local camera 11 (such as a smartphone), and a remote part 72 may be executed by remote viewing station 12 and/or by an imaging server 16. In some configurations local camera 11 (and/or a computing device associated with local camera 11) may also execute modules and/or components of remote part 72 and vice versa.

As shown in FIG. 10, local part 71 and remote part 72 communicate between them by exchanging data. It is appreciated that local part 71 and remote part 72 may be executed in the same time, simultaneously and/or synchronously.

As shown in FIG. 10, remote part 72 may include a panorama module 73, a motion display module 74, motion indication collection module 75, and camera indication collection module 76. It is appreciated that modules of remote part 72 may be executed by a processor of remote viewing station 12 in real-time, in parallel, and/or simultaneously.

As shown in FIG. 10, local part 71 may include a motion-position detection module 77, a motion orientation module 78, and a camera-orientation module 79. It is appreciated that modules of local part 71 may be executed by a processor of local camera 11 (and/or a computing device associated with local camera 11) in real-time, in parallel, and/or simultaneously, and/or synchronously.

Consequently, user-orientation software 17 as described with reference to FIG. 10, including local part 71 and remote part 72, may execute a process such as orientation process 45 as shown and described with reference to FIG. 4, which may represent a process for orienting a user and/or a camera by remote user-orientation system 10 in a communication channel 36 as shown and described with reference to FIG. 3.

Panorama module 73 (of remote part 72) may start with step 80 by collecting source images of the local scenery. Such images may be obtained from local camera 11 (e.g., low-resolution images 40 and capture data 41 as shown and described with reference to FIG. 4) as well as various other sources such as the Internet. Panorama module 73 may proceed to step 81 to create a panorama image (e.g., image 38, 42 of FIG. 4) from the source images.

Panorama module 73 may proceed to step 82 to determine one or more vanishing points of the panorama image and to display the panorama image (step 83). Optionally, panorama module 73 may also communicate the panorama image to local camera 11, and/or the computing device associated with local camera 11 (step 84).

Motion-position detection module 77 (of local part 71) may start in step 85 by receiving the panorama image from panorama module 73 (of remote part 72). Motion-position detection module 77 may then proceed to step 86 to compute the position and the motion direction and speed of the local-user (or the camera 11) with respect to the panorama image. Motion-position detection module 77 may then communicate (step 87) the position data and motion vector to motion display module 74 of remote part 72 (as well as to the motion orientation module 78 and camera-orientation module 79).

Motion display module 74 (of remote part 72) may start with step 88 by receiving from motion-position detection module 77 (of local part 71) motion and/or position data of the local-user. Motion display module 74 (of remote part 72) may then create a graphical motion vector and display it on the display screen of remote viewing station 12 (step 89). For example, the graphical motion vector may take the form of sign 60 of FIG. 7.

Motion indication collection module 75 may then enable the remote-user operating remote viewing station 12 to indicate a required direction of motion for the local-user operating camera 11, or a sequence of such required direction of motion indications. Camera indication collection module 76 may then enable the remote-user operating remote viewing station 12 to indicate one or more points, or areas, of interest. For example, the required direction of motion indications may take the form of required motion vector indicator 61 of FIG. 7, and the points, or areas, of interest may take the form of indicators 66 of FIG. 7.

The motion direction indication(s) 61 (or direction indication 49 of FIG. 4) are then communicated to the motion orientation module 78 (of local part 71) and (optionally) the points, or areas, of interest (53, 54) are communicated to the camera-orientation module 79 (of local part 71).

Motion orientation module 78 (of local part 71) may start with step 90 by receiving the required motion indicator from motion indication collection module 75 and then compute a motion cue and provide it the local-user (step 91).

Camera-orientation module 79 (of local part 71) may start with step 92 by receiving one or more required points (or areas) of interest indications from Camera indication collection module 76 and then compute a camera-orientation cue and provide it the local-user (step 93). When camera 11 is oriented according to the required camera-orientation indication camera-orientation module 79 may proceed to step 94 to operate camera 11 automatically to capture the required image, or instruct the local-user to capture the required image (using a special cue), and then send the image to the panorama module 73 in remote viewing station 12.

It is appreciated that at some, and preferably all, of the modules of local part 71 and/or remote part 72 may loop indefinitely, and execute in parallel, and/or simultaneously.

Any and/or both of the local part 71 and the remote part 72 may include an administration and/or configuration module (not shown in FIG. 10), enabling any and/or both the local-user and the remote-user to determine parameters of operation.

For example, the administration and/or configuration module may enable a (local or remote) user to associate a cue type (e.g., visual, audible, tactile, etc.) with an orientation module. For example, a user may determine that motion orientation module 78 may use tactile cues and camera-orientation module 79 may use audible cues.

For example, the administration and/or configuration module may enable a (local or remote) user to determine cue parameters. For example, the administration and/or configuration module may enable a user to set the pitch resolution of an audible cue. For example, a user may set the maximum pitch frequency, and/or associated the maximum pitch frequency with a particular deviation (e.g., the difference between the current orientation and the required orientation).

For example, the administration and/or configuration module may enable a (local or remote) user to determine cue parameters such as linearity or non-linearity of the cue as described above.

For example, the administration and/or configuration module may enable a (local or remote) user to adapt the ‘speed’, or the ‘parallelism’, of the remote-user-orientation system 10 to the agility of the local user 14. For example, by adapting the rate of repetition of a cue, or the rate of alternating between cue types (user-orientation and camera-orientation) to the ability of the user to physically respond to relevant cue.

It is appreciated that at least some of the configuration parameters may be adapted automatically using, for example, artificial intelligence or machine learning modules. Such AI, ML, and/or BD module may automatically characterize types of users by their motion characteristics and camera handling characteristics, automatically develop adaptive and/or optimized configuration parameters, and automatically recognize the user's type and set such optimized configuration parameters for the particular user type.

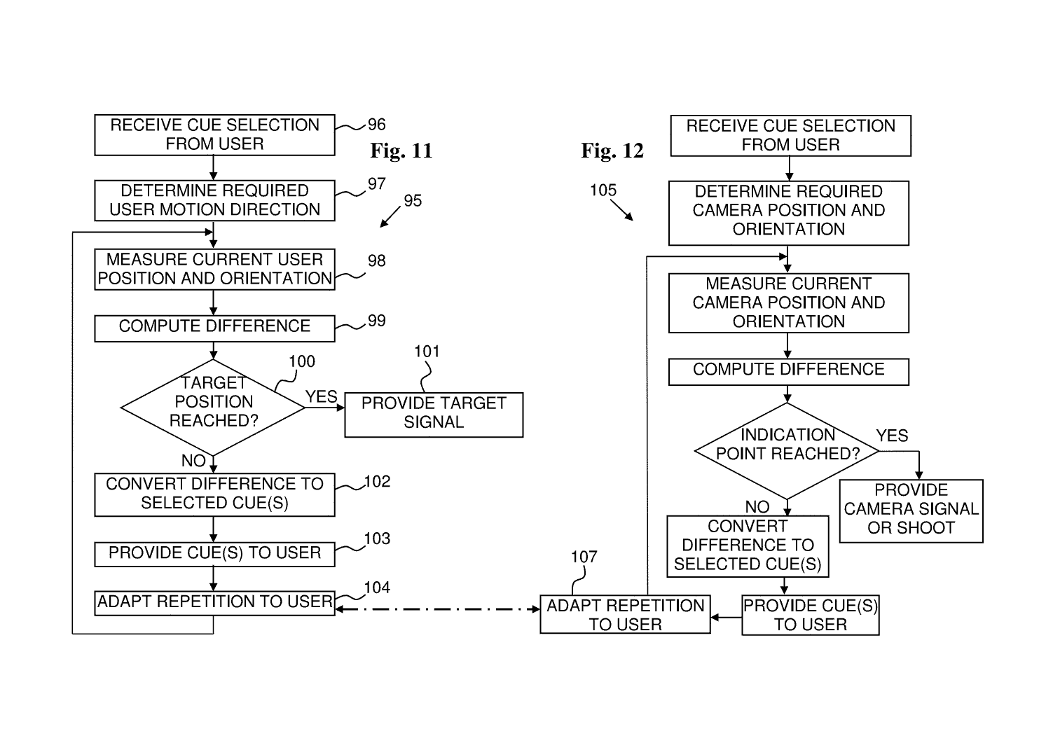

Reference is now made to FIG. 11, which is a simplified flow-chart of user-orientation module 95, according to one exemplary embodiment.

As an option, the flow-chart of user-orientation module 95 of FIG. 11 may be viewed in the context of the details of the previous Figures. Of course, however, the flow-chart of user-orientation module 95 of FIG. 11 may be viewed in the context of any desired environment. Further, the aforementioned definitions may equally apply to the description below.

User-orientation module 95 may be part of motion orientation module 78, and typically correspond to element 91 of FIG. 10, by providing motion and orientation cues to the local-user, based on one or more motion indicators received from the remote viewing station 12 and/or an imaging server 16.

As shown in FIG. 11, user-orientation module 95 may start with step 96 by receiving from the local-user a selection of the cue type to be used for user-orientation (rather than camera-orientation). As discussed before, such selection may be provided by a remote user or by an AI, ML, and/or BD, machine.

User-orientation module 95 may then proceed to step 97 to compute the required user-orientation and motion direction, typically according to the motion vector indicator 61 (or direction indication 49 of FIG. 4) received from the remote viewing station and/or an imaging server 16.

User-orientation module 95 may then proceed to step 98 to measure the current user position and orientation, and then to step 99 to compute the difference between the current user position and orientation and the required user position, orientation, and motion direction.

If the target position is reached (step 100) user-orientation module 95 may issue a target signal to the local-user (step 101). If the target position is not reached, user-orientation module 95 may proceed to step 102 to convert the difference into a cue signal of the cue type selected in step 96, and then to step 103 to provide the cue to the local-user. Steps 98 to 100 and 102 to 103 are repeated until the target position is reached. Optionally, user-orientation module 95 may adapt the repetition rate of steps 98 to 100 and 102 to 103 for example to the agility of the local user, for example with a stay of optional step 104.

Reference is now made to FIG. 12, which is a simplified flow-chart of camera-control module 105, according to one exemplary embodiment.

As an option, the flow-chart of camera-control module 105 of FIG. 12 may be viewed in the context of the details of the previous Figures. Of course, however, the flow-chart of camera-control module 105 of FIG. 12 may be viewed in the context of any desired environment. Further, the aforementioned definitions may equally apply to the description below.

Camera-control module 105 may be part of camera-orientation module 79, and typically correspond to element 93 of FIG. 10, by providing camera-orientation cues to the local-user, based on one or more point and/or area indicators received from the remote viewing station 12 and/or an imaging server 16.

As shown in FIG. 12, camera-control module 105 is similar in structure and function to user-orientation module 95, except that it may use a different cue type, use point and/or area indicators (instead of motion vector indicator) and operate the camera when the required camera-orientation is reached.

It is appreciated that step 106 of the user-orientation module 95 adapting the repetition rate of the user-orientation cue to the particular user, and the similar step 107 of camera-control module 105, may communicate to synchronize the provisioning and repetition rates of the two user-orientation cues and camera-orientation cues.

As discussed above, remote viewing station 12 and/or imaging server 16 may execute artificial intelligence (AI) and/or machine learning (ML) and/or big-data (BD) technologies to assist remote-user 15, or to replace remote-user 15 for particular duties, or to replace remote-user 15 entirely, for example, during late night time. Assisting or partly replacing remote-user 15 may be useful, for example, when a remote-user is assisting a plurality of local-users 14. Therefore, the use of AI and/or ML and/or BD may improve the service provided to the local-users 14 by offloading some of the duties of the remote-user 15 and thus improving the response time.

Remote-user-orientation system 10 may implement AI and/or ML and/or BD as one or more software programs, executed by one or more processors of the remote viewing station 12 and/or imaging server 16. This remote AI/ML/BD software program may learn how a remote-user 15 may select and/or indicate motion vector indicator and/or a point and/or area of interest.

Particularly, remote AI/ML/BD software programs may automatically identify typical sceneries, and may then automatically identify typical scenarios leading to typical indications of motion vectors and/or of points/areas of interest.

For example, the remote AI/ML/BD software program may learn to recognize a scenery such as a hotel corridor, a mall, a train station, a street crossing, a bus stop, etc.

For example, the remote AI/ML/BD software program may learn to recognize a scenario such as a looking for a particular room in the hotel corridor, seeking elevators in a mall, looking for a ticketing station in a train station, identifying the appropriate traffic light change to green in a street crossing, finding a particular bus in a bus stop, etc.

For example, the remote AI/ML/BD software program may further gather imaging data of many hotels, and hotel corridors, and may learn to recognize a typical hotel corridor, a typical door of a hotel room, as well as a typical room number associated with the door.

Once the remote AI/ML/BD has identified a particular scenery such as a hotel corridor, the software program may further use the database of hotel corridors to recognize the particular hotel corridor, as well as the particular room door and number location.

Once the remote AI/ML/BD has identified the scenery as a hotel corridor, the software program may further identify the scenario, for example, looking for the particular room (number) or looking for the elevators, or any other scenario associated with a hotel corridor.

The AI/ML/BD software program may then develop a database of typical scenarios, typically associated with respective sceneries. Looking for a room number in a corridor may be useful in a hotel, office building, apartment building, etc., with possible typical differences.

The AI/ML/BD software program may then develop a database of typical assistance sequences as provided by remote-users to local-users in typical sceneries and/or typical scenarios.

The remote AI/ML/BD software program may then use the databases to identify a scenery and a scenario and to automatically generate and send to the camera 11, or the computing device associated with the camera, a sequence of indications of motion vector(s) and points of interest.

For example, for a scenery of the hotel corridor and a scenario of looking for a room number, the sequence may include: capturing forward look along the corridor, providing a motion vector indicator guiding the local-user along the corridor, orienting the camera and capturing a picture of a door aside, and then, based on the door image, orienting the camera and capturing an image of the room number.

The remote AI/ML/BD software program may be semi-automatic, for example, by interacting with the remote-user. For example the remote AI/ML/BD software program may identify and/or indicate one or more possible sceneries and thereafter one or more possible scenarios and requesting the remote-user to confirm or select the appropriate scenery and/or scenario. The remote AI/ML/BD software program may then propose one or more sequences of motion vector indictor(s) and/or points/areas of interest and request the remote-user to confirm, select and/or modify the appropriate sequence and/or indicator. Alternatively, the remote AI/ML/BD software program may consult with the local-user directly, for example by using synthetic speech (e.g., text-to-speech software).

The remote AI/ML/BD software program may continuously develop one or more decision-trees for identifying sceneries and scenarios, and selecting appropriate assistance sequences. The remote AI/ML/BD software program may continuously seek correlations between sceneries, and/or between scenarios, and/or between assistance sequences. The remote AI/ML/BD software program may continuously cluster such correlated sceneries, and/or scenarios, and/or assistance sequences to create types and subtypes.

The remote AI/ML/BD software program may then present to the remote-user typical differences between clusters and, for example, enable the remote-user to dismiss a difference, or characterize the difference (as two different clusters types). For example, confirming differentiation between a noisy environment and a quite environment, between day-time and night-time scenarios, etc.

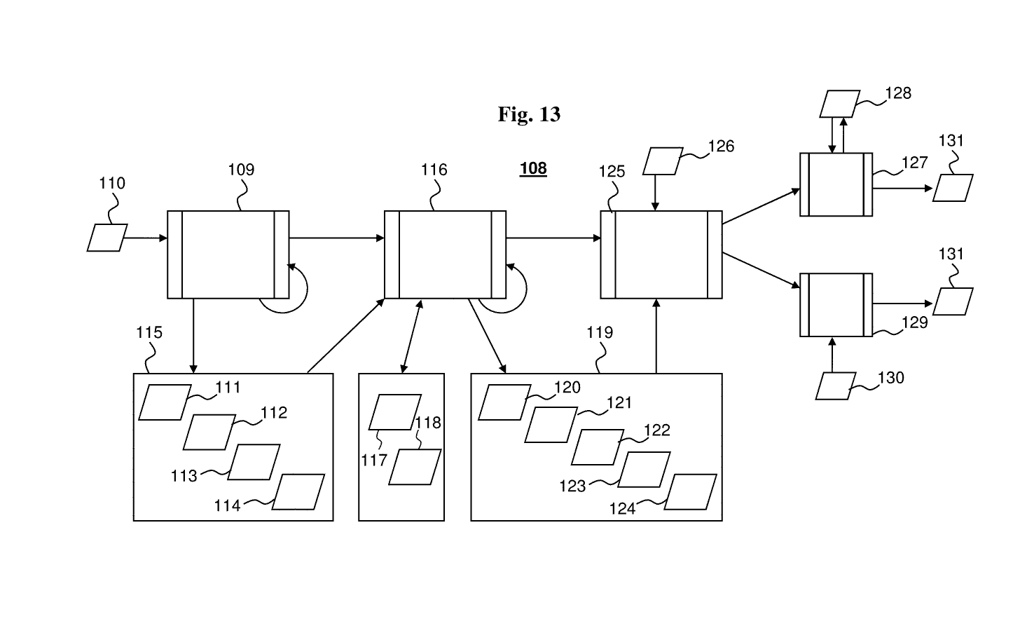

Reference is now made to FIG. 13, which is a block diagram of remote-user-orientation system 10 including remote AI/ML/BD software program 108, according to one exemplary embodiment.

As an option, the block-diagram of FIG. 13 may be viewed in the context of the details of the previous Figures. Of course, however, the block-diagram of FIG. 13 may be viewed in the context of any desired environment. Further, the aforementioned definitions may equally apply to the description below.

As shown in FIG. 13, remote AI/ML/BD software program may have the following main modules:

A data collection module 109 that may collect input data 110 such as images 111, including panorama images, assistance indications 112 including motion vector indicators, camera-orientation indicators (e.g., points/areas of interest), etc., remote-user instructions/preferences 113, and local-user preferences 114 (e.g., selected cue types). Data collection module 109 typically stores the collected data in collected data database 115. Data collection module 109 typically executes continuously and/or repeatedly, and/or whenever a remote user or a remote system assists a local user.

A data analysis module 116 that may analyze the collected data in collected data database 115, create and maintain a database of sceneries 117 and a database of scenarios 118, and develop a database 119 of rules for identifying sceneries 120, scenarios 121, assistance sequences 122, remote-user preferences 123, and local-user behaviors and/or preferences 124. Data analysis module 116 typically executes continuously and/or repeatedly, and/or whenever new data is added to collected data database 115.

An assistance module 125 that may analyze, in real-time, the input data 126 provided by a particular local-user and/or camera 11, and produce assistance information based on optimal selection of scenery, scenario, assistance sequence, remote-user preferences (if applicable), and local-user preferences, according to rules derived from rules database 119. Assistance module 125 typically executes whenever a remote user or a remote system assists a local user. Assistance module 125 may operate in parallel for a plurality local users and/or cameras providing their respective plurality of input data 126.

A semi-automatic assistance module 127 may provide assistance to a remote-user, receiving remote-user selection 128. An automatic assistance module 129 may provide assistance to a local-user, receiving local-user selection 130. Assistance module 125 together with semi-automatic assistance module 127 and/or automatic assistance module 129 provide assistance data 131 to the local user, such as by providing indications, such as required direction indication 49, motion vector indicator 61, indication point 53 and/or indication area 54.

The goal of the AI/ML/BD software program 108 is to provide an optimal sequence of assistance data 131. This sequence of assistance data 131 may include one or more indications, such as required direction indication 49, motion vector indicator 61, indication point 53, and/or indication area 54, thus providing an indication sequence.

The AI/ML/BD software program 108 may provide indication point 53 and/or indication area 54 to capture images to augment, and/or confirm, and/or correct respective direction indication 49, and/or motion vector indicator 61. Similarly, The AI/ML/BD software program 108 may provide direction indication 49, and/or motion vector indicator 61 to position the local user in a location where the camera may capture desired images according to respective indication point 53 and/or indication area 54. Thus The AI/ML/BD software program 108 may use the collected data to direct the local user to the required destination.

The AI/ML/BD software program 108 may achieve this goal by matching the optimal scenery, scenario, and indication sequence per the desired destination of the particular local user (augmented by optimal selection of cues, repetition rates, etc.). This matching process is executed both by the data analysis module 116 when creating the respective rules, and by assistance module 125 when processing the rules.

Data analysis module 116 may correlate sceneries, correlates scenarios, and correlates indication sequences provided by remote users, and then correlates between typical scenarios and sequences as well as typical indication sequences.

Typically, the indication sequence is provided a step at a time, typically as a single direction indication 49, and/or motion vector indicator 61 accompanied by one or more indication points 53 and/or indication areas 54. The images captured responsive to the respective indication points 53 and/or indication areas 54 serve to create a further set of indications, including direction indication 49, and/or motion vector indicator 61 accompanied by one or more indication points 53 and/or indication areas 54.

Each such indication set may be created by the AI/ML/BD software program 108, and particularly by the assistance module 125, based on the respective rules of rules database 119. The rules enable the assistance module 125 to identify the best match scenery, scenario, and assistance sequence. The assistance module 125 then advances through the assistance sequence a step at a time (or an indication set at a time), verifying the best match continuously, based on the captured images collected along the way.

To create the appropriate rules, data analysis module 116 may analyze data such as location data (based, for example, on GPS data, Wi-Fi location data, etc.), orientation data (based, for example, on compass, and/or magnetic field measurements, and/or gyro data), motion vector data (based, for example, on accelerometer data, and/or gyro data) as well as imaging data (using, for example image recognition) to derive parameters that may characterize particular sceneries, and/or scenarios.

Assistance module 125 may then derive such parameters from input data 126. For example, from images 40 and the accompanying capture data 41. Assistance module 125 may then retrieve from rules database 119 that are applicable to the collected parameters. Executing the retrieved rules, assistance module 125 may calculate probability values for one or more possible sceneries, scenarios, etc. If, for example, the probability of two or more possible sceneries, and/or scenarios, is similar, assistance module 125 may request the local user, and/or the remote user, to select the appropriate sceneries, and/or scenarios, etc.

It is appreciated that the remote AI/ML/BD software program may access a database of particular scenarios to identify the locality in which the local-user is located and use sequences already prepared for the particular scenario. For example, if the particular hotel corridor was already traveled several times, even by different local-users, possibly assisted by different remote-users, an optimal sequence may have been created by the remote AI/ML software program. Thus, the remote AI/ML software program may continuously improve the sequences used.

It is appreciated that in some cases the remote AI/ML/BD software program may be executed, entirely or partially, by the camera 11, or by a computing device associated with the camera, such as a smartphone.

Additionally or alternatively, remote user-orientation system 10 may implement AI and/or ML and/or BD as a software program, executed by a processor of camera 11, or a computing device associated with the camera, such as a smartphone. This local AI/ML/BD software program may learn the behavior of local-user 14 and adapt the cueing mechanism to the particular local-user 14. Particularly, local AI/ML/BD software program may learn how fast, and/or how accurate, a particular local-user 14 responds to a particular type of cue. Local AI/ML/BD software program may then issue a corrective cue adaptive to the typical user response.

Remote user-orientation system 10 may then analyze these databases using AI/ML/BD technologies and produce automatic processes for recognizing particular sceneries, recognizing particular scenarios, and automatically generating indication sequences that are optimal to the scenery, scenario, and particular local-user.

In this respect, the remote user-orientation system 10 may maintain one or more of: database of sceneries, where a scenery comprises at least one of said imaging data, a database of scenarios, where a scenario comprises at least one required direction of motion within a scenery, a database of user-preferences for at least one local-user, and a database of user-preferences for at least one remote-user operating a remote station.

The remote user-orientation system 10 may then compute at least one correlation between the image data collected in real-time from an imaging device associated with a local-user and the database of sceneries, and/or the database of scenarios.

Thereafter the remote user-orientation system 10 may perform at least one of the following operations: Determine a required direction of motion according to any of the above mentioned correlations or combinations thereof. Determine a required direction of motion according to a local-user preference and/or a remote-user preference, preferably associated with at least one of the correlations described above. And, determine a cue according to a local-user preference, preferably associated with at least one of the correlations described above.

It is appreciated that at least some parts of indications creation processes, particularly when automated as described above with reference to AI/ML/BD, may be executed by the local camera 11 or by the computing device associated with camera 11. For example, local camera 11 (or the associated computing device) may automatically recognize the scenery, and/or recognize the scenario, and/or automatically generate indications to collect necessary images and send them to the remote-user.

It is appreciated that such procedures, or rules, as generated by machine learning processes, may be downloaded to the local camera 11 (or the associated computing device) from time to time. Particularly, the local camera 11 (or the associated computing device) may download such processes, or rules, in real time, responsive to data collected from other sources. For example, a particular procedure, or rule-set, adapted to a particular location (scenery), may be downloaded on-demand according to geo-location data such as GSP data, cellular location, Wi-Fi hot-spot identification, etc. If more than one scenario applies to the particular location the local camera 11 (or the associated computing device) may present to the local-user a menu of such available scenarios for the user to select.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A method for remotely orienting a first user, the method comprising:
communicating in real-time, from an imaging device associated with said first user, to a remote station, imaging data acquired by said imaging device;
analyzing said imaging data to provide actual direction of motion of said first user;
acquiring, by said remote station, an indication of a required direction of motion of said first user;
communicating said indication of a required direction of motion to a computing device associated with said first user; and
providing, by said computing device to said first user, at least one humanly sensible cue, wherein said cue indicates a difference between said actual direction of motion of said first user and said indication of said required direction of motion of said first user.

2. The method according to claim 1, additionally comprising at least one of:
analyzing said imaging data, by said remote station, to provide actual direction of motion of said first user;
analyzing said imaging data, by said computing device associated with said first user, to provide actual direction of motion of said first user;
visualizing said direction of motion of said first user, by said remote station, to a user operating said remote station;
acquiring said indication of a required direction of motion of said first user from a user operating said remote station;
communicating said actual direction of motion of said first user as analyzed by said remote station to said computing device associated with said first user along with said indication of a required direction of motion;
calculating said motion difference between said actual direction of motion of said first user and said required direction of motion of said first user by said computing device associated with said first user; and
calculating said motion difference between said actual direction of motion of said first user and said required direction of motion of said first user by said remote station, and communicating said motion difference from said remote station to said computing device associated with said first user.

3. The method according to claim 1, additionally comprising:
acquiring, by said remote station, from said user operating said remote station, a point of interest;
calculating an imaging difference between actual orientation of said imaging device and said point of interest; and
providing, by said imaging device to said first user, an indication of said imaging difference,
wherein said imaging difference is adapted to at least one of:
said difference between said actual direction of motion of said first user and said indication of a required direction of motion; and
current location of said first user; and
wherein said indication of imaging difference is humanly sensible.

4. The method according to claim 3, additionally comprising at least one of:
communicating said point of interest from said remote station to said imaging device;
calculating said imaging difference by said imaging device;
calculating said imaging difference by said remote station; and
communicating said imaging difference from said visualizing station to said imaging device.

5. The method according to claim 1, additionally comprising
maintaining at least one of:
database of sceneries, wherein a scenery comprises at least one of said imaging data;
a database of scenarios, wherein a scenario comprises at least one required direction of motion within a scenery;
a database of user-preferences for at least one said first user; and
a database of user-preferences for at least one said user operating said remote station;
computing at least one correlation between said image data and at least one of: said database of sceneries, and said database of scenarios; and
performing at least one of:
determining said required direction of motion according to said at least one correlation;
determining said required direction of motion according to at least one of first user preference and remote user preference associated with a said at least one correlation; and
determining said cue according to a first user preference associated with said at least one correlation.

6. A remote station for remotely orienting a first user, the remote station comprising:
a communication module operative to:
communicate in real-time with at least one of:
a computing device associated with said first user; and
an imaging device associated with said first user;
receive imaging data acquired by said imaging device; and
communicate an indication of a required direction of motion of said first user to said computing device;
an analyzing module, analyzing said imaging data to provide actual direction of motion of said first user; and
an input module, acquiring said indication of a required direction of motion of said first user;
wherein said indication of said required direction of motion enables said computing device to provide to said first user at least one humanly sensible cue, and
wherein said cue indicates a difference between said actual direction of motion of said first user and said indication of said required direction of motion of said first user.

7. The remote station according to claim 6, additionally comprising:
at least one user-interface module for at least one of:
visualizing said direction of motion of said first user, by said remote station, to a user operating said remote station; and
acquiring said indication of a required direction of motion of said first user from a user operating said remote station;
said communication module additionally operative to communicate said actual direction of motion of said first user as analyzed by said remote station to said computing device associated with said first user along with said indication of a required direction of motion; and
a module for calculating said motion difference between said actual direction of motion of said first user and said required direction of motion of said first user by said remote station, and communicating said motion difference from said remote station to said computing device associated with said first user.

8. The remote station according to claim 6 additionally comprising:
said user-interface module is additionally operative to acquire from a user operating said remote station a point of interest; and
said analyzing module is additionally operative to calculate an imaging difference between actual orientation of said imaging device and said point of interest; and
said communication module is additionally operative to communicate at least one of said point of interest and imaging difference to said computing device.

9. The remote station according to claim 6, additionally comprising:
a software program to determine said required direction of motion.

10. The remote station according to claim 9, wherein said software program comprises at least one of artificial intelligence, big-data analysis, and machine learning, to determine said point of interest.

11. The remote station according to claim 10, wherein said at least one of artificial intelligence, big-data analysis, and machine learning, additionally comprises:
computing at least one correlation between said captured image and at least one of:
a database of sceneries, and a database of scenarios; and at least one of:
determining said required direction of motion according to said at least one correlation;
determining said required direction of motion according to at least one of first user preference and second user preference associated with a said at least one correlation; and
determining said cue according to a first user preference associated with said at least one correlation.

12. A computing device for remotely orienting a first user, the computing device comprising:
a communication module communicatively coupled in real-time with a remote system and operative to:
communicate to said remote system imaging data acquired by an imaging device associated with said computing device; and
receive from said remote system an indication of a required direction of motion of said first user; and
a user-interface module providing said first user at least one humanly sensible cue;
wherein said cue indicates a difference between said actual direction of motion of said first user and said indication of a required direction of motion.

13. The computing device according to claim 12, additionally comprising at least one of:
a motion analysis module providing actual direction of motion of said first user;
said communication module receiving from said remote system actual direction of motion of said first user; and
said user-interface module calculating said motion difference between said actual direction of motion of said first user and said required direction of motion of said first user by said computing device associated with said first user.

14. The computing device according to claim 12, additionally comprising:
said communication unit is additionally operative to receive from said remote system at least one of: a point of interest and imaging difference; and
wherein said user-interface module is additionally operative to provide to said first user said a humanly sensible indication of said imaging difference, wherein said imaging difference is adapted to at least one of:
difference between said actual direction of motion of said first user and said indication of a required direction of motion; and
difference between current location of said first user and said point of interest.

15. A computer program product embodied on a non-transitory computer readable medium, comprising computer code that, when executed by a processor, performs at last one of:
in a computing device associated with a first user:
communicate to said remote system imaging data acquired by an imaging device associated with said computing device; and
receive from said remote system an indication of a required direction of motion of said first user; and
providing said first user at least one humanly sensible cue;
in a remote station:
communicate in real-time with at least one of:
said computing device associated with said first user; and
an imaging device associated with said first user;
receive imaging data acquired by said imaging device; and
acquire an indication of a required direction of motion of said first user;
communicate said indication of a required direction of motion of said first user to said computing device; and
analyze said imaging data to provide actual direction of motion of said first user;
wherein said cue indicates a difference between said actual direction of motion of said first user and said indication of a required direction of motion.

16. The computer program product according to claim 15, wherein said code is additionally operative to perform at least one of:
visualize said direction of motion of said first user to a user operating said remote station; and
acquire said indication of a required direction of motion of said first user by said remote station from a user operating said remote station.

17. The computer program product according to claim 15, wherein said code is additionally operative to perform at least one of:
in said remote station
acquire, from said user operating said remote station, a point of interest;
calculate an imaging difference between actual orientation of said imaging device and said point of interest; and
communicate to said computing device at least one of:
point of interest; and
said difference between actual orientation of said imaging device and said point of interest; and
in said computing device associated with said first user:
receive from said remote station at least one of:
said point of interest;
said difference between actual orientation of said imaging device and said point of interest;
provide to said first user a humanly sensible cue indicating said difference between said actual orientation of said imaging device and said point of interest,
calculate said imaging difference by at least one of said imaging device and said remote station;
wherein said cue is adapted to at least one of:
said difference between said actual direction of motion of said first user and said indication of a required direction of motion; and
current location of said first user.

18. The computer program product according to claim 15, wherein said code is additionally operative to determine said required direction of motion.

19. The computer program product according to claim 18, wherein said wherein said code is additionally operative to use at least one of: artificial intelligence, big-data analysis, and machine learning, to determine said point of interest.

20. The computer program product according to claim 19, wherein said at least one of artificial intelligence, big-data analysis, and machine learning, additionally comprises:
computing at least one correlation between said captured image and at least one of:
a database of sceneries, and a database of scenarios; and at least one of:
determining said required direction of motion according to said at least one correlation;
determining said required direction of motion according to at least one of first user preference and second user preference associated with a said at least one correlation; and
determining said cue according to a first user preference associated with said at least one correlation.
